(19) United States
(12) Patent Application Publication
(10) Pub. No.: US 2015/0089240 A1
(43) Pub. Date: Mar. 26, 2015

(54) Biometric management system

(71) Applicant: Dmitri Itkis, Beaverton, OR (US)

(72) Inventor: Dmitri Itkis, Beaverton, OR (US)

(21) Appl. No.: 14/033,443

(22) Filed: Sep. 21, 2013

(51) Int. Cl. H04L 29/06

(52) U.S. Cl. CPC H04L 63/0861
USPC 713/186

(57) ABSTRACT

The invention is directed toward a system and method of verifying the identity of a person based on biometric information. The system includes a server computer, a client computer, a software application, and a biometric device. The software application applies a hash algorithm to the biometric information input into the system, permitting the storage of a hash value. A user inputs initial biometric information and a hash value of that biometric information is stored. At a later time the user inputs verification biometric information. The system creates a second hash value and confirms the identity of the user by comparing the hash values. The system permits a user to create a social network with other users. A user may create a response function in the system which is performed when a second user is granted permission based on a level of social connection and confirms his identity.

### FIELD OF THE INVENTION

The invention relates to biometric systems and more particularly to a system and method of securely transmitting and utilizing biometric information.

### BACKGROUND OF THE INVENTION

Biometric information is information that is unique to a specific individual. Such biometric information may include fingerprints, the shape of a person's face, a person's hair color and eye color, a person's blood type, DNA, or any other personal information or physical attribute which may be used to uniquely identify one person over another.

Biometrics present a unique solution to restricting access to computer systems or physical locations. In U.S. Pat. No. 7,404,086, a biometric authentication method is disclosed. The patent provides for a biometric authentication system in a client server architecture. The patent provides for a system that stores biometric information of a user on a server. A user submits biometric information to be stored on the server at the time of enrollment. When a user is later required to authenticate the user's identity, the user is required to input biometric information at a client computer. The server computer then compares the newly input biometric information against the biometric information stored on the server. Such a system is limited in that highly sensitive biometric information of multiple users are stored on one server system outside of the control of the respective users. This wealth of biometric information stored on a database presents a likely target for hackers and identity thieves. The manager of the server computer is thus required to expend a large amount of resources simply to protect and manage the database of stored biometric information. One possible solution to this issue is to require systems to store full raw biometric information on the client computer. This solution is limited in that client devices may become damaged, lost, or stolen, undermining the security of the biometric information. Likewise, if a user replaces a client device then the user must reprogram new client device and create a new biometric information benchmark file. In addition this solution may not be utilized in any type of preauthorization or remote access system because the biometric information file that must be utilized to confirm a user's identity would be presented off site from the location where the user desires to confirm his identity. Thus, what is needed is a means for storing and utilizing biometric information of multiple users in a method which does not require a full amount of a user's biometric information to be stored in a central location.

Furthermore, biometric systems known in the prior art are limited in that the systems do not account for the social aspect of human existence. The prior art does not permit an individual to control access to files or locations to additional individuals who are known to and are socially connected with the first individual. What is needed is a system and method for verifying the biometric information of a user and social connections of the user. What is further needed is a system and method whereby a user may set limitations and permissions for social connections through the system to gain access to user controlled documents or items once the social connection has verified their identity through the system and the system has confirmed that the person is indeed a social connection with the first user.

### SUMMARY OF THE INVENTION

The invention is directed toward a system for verifying biometric information comprising a client computer, a server computer, a first biometric device, and a first software application. The client computer and the server computer are connected through a network. The biometric device receives biometric information. The first software application processes initial biometric information by means of a hash algorithm to create a first hash value. The first software application processes secondary biometric information by means of a hash algorithm to create a second hash value. The first software application then compares the first hash value to the second hash value. The first software application verifies the identity of a user based upon the results of the comparison. In another embodiment of the invention, the system further comprises a database connected to the server computer wherein the database stores information regarding a user in connection with the first hash value. In this embodiment, the first biometric device may be connected to the client computer or the first biometric device may be connected to the server computer through a network. In another embodiment of the system the first biometric device is connected to the client computer and the system further comprises a second biometric device wherein the second biometric device is connected to the server computer through a network.

In another embodiment of the invention, the first biometric device is connected to the client computer and the system verifies the identity of a user. The identity of a user is verified when the second hash value is identical to the first hash value.

In another embodiment of the invention the first biometric device is connected to the client computer and the system verifies the identity of a user. The identity of a user is verified when the second hash value is substantially identical to the first hash value. A system administrator may vary the percentage of similarity required between the first hash value and the second hash value for such similarity to be determined substantially identical. Furthermore, the system performs a response function when the first hash value is substantially identical to the second hash value. The response function of the system may be any function. Such functions may include, but are not limited to, permitting the user to gain access to a computer, permitting the user to gain access to an electric data file, or unlocking a door. Furthermore, this embodiment may be further limited by means of social networking of users. A first user of the system may connect with other users of the system into a social network. The first user of the system may limit the response function for first user controlled functions to other users based upon the level of social connection of the other users to the first user. The first user controlled functions would include any limitation or function created or dependent upon the first user, or over which the first user has administrative authority. For instance, a first user may create an electronic document. By virtue of creating the electronic document the first user has administrative authority over such electronic document. By having administrative authority over the electronic document, the first user may control access of the document to other users. Access to the electronic document would be a first user controlled function. In this example, the response function would be opening the electronic document for reading or editing. The first user may limit ability to open and read or edit the electronic document only to those users who are social connections with the first user and are able to verify their identity. In another embodiment of the invention the first user may further limit the response function for first user controlled functions to other users based upon additional first user created parameters. Such other parameters could include any basis chosen by the first user. Such additional first user created parameters could include, but are not limited to, specific time, time frame, physical location, or role of the other user. In this embodiment the first software application may reside on the client computer or the first software application may reside on the server computer.

In one embodiment of the invention, the invention is directed toward a system for verifying biometric information comprising a client computer, a server computer, a first biometric device, and a first software application. The client computer and the server computer are connected through a network. The biometric device receives biometric information. The first software application processes initial biometric information by means of a hash algorithm to create a first hash value. The first software application processes secondary biometric information by means of a hash algorithm to create a second hash value. The first software application then compares the first hash value to the second hash value. The first software application verifies the identity of a user based upon the results of the comparison. The first software application resides on the client computer. The client computer transfers the first hash value to the server computer.

In a separate embodiment of the invention, the invention is directed toward a system for verifying biometric information comprising a client computer, a server computer, a first biometric device, and a first software application. The client computer and the server computer are connected through a network. The biometric device receives biometric information. The first software application processes initial biometric information by means of a hash algorithm to create a first hash value. The first software application processes secondary biometric information by means of a hash algorithm to create a second hash value. The first software application then compares the first hash value to the second hash value. The first software application verifies the identity of a user based upon the results of the comparison. The first software application resides on the server computer and the client computer transfers biometric information to the server computer.

In another embodiment of the invention, the invention comprises a client computer, a server computer, a database connected to the server computer, a first biometric device, a first software application, and a second software application. The client computer and the server computer are connected through a network. The database stores information regarding a user in connection with the first hash value. The biometric device receives biometric information. The first biometric device is connected to the client computer. The first software application resides on the server computer. The first software application processes initial biometric information by means of a hash algorithm to create a first hash value. The first software application processes secondary biometric information by means of a hash algorithm to create a second hash value. The first software application transmits the first hash value and the second hash value to the server computer through a network. The second software application resides on the server computer. The second software application processes the first hash value by means of a hash algorithm to create a third hash value. The second software application processes the second hash value by means of a hash algorithm to create a fourth hash value. The second software application compares the third hash value to the fourth hash value. The identity of a user is verified when the third hash value is substantially identical to the fourth hash value. A system administrator may vary the percentage of similarity required between the third hash value and the fourth hash value for such similarity to be determined substantially identical. The system performs a response function when the third hash value is substantially identical to the fourth hash value. A first user of the system may connect with other users of the system into a social network. The first user of the system may limit the response function for first user controlled functions to other users based upon the level of social connection of the other users to the first user. The first user may further limit the response function for first user controlled functions to other users based upon additional first user created parameters.

The invention is also directed toward a method of verifying biometric information comprising the steps of creating a user profile for a user, receiving initial biometric information from the user during an enrollment process, processing the initial biometric information by means of a first hash algorithm to create a first hash value, storing the first hash value in connection with the user profile, receiving verification biometric information from the user during a verification process, processing the verification biometric information by means of a hash algorithm to create a second hash value, comparing the first hash value to the second hash value, and verifying the user's identity when the first hash value and the second hash value are substantially identical. In this method a system administrator may vary the percentage of similarity required between the first hash value and the second hash value for such similarity to be determined substantially identical.

In another embodiment of the invention, the method further comprises performing a response function when the first hash value and the second hash value are substantially identical. Furthermore, the method may further comprise permitting a first user of the system to connect with other users of the system into a social network and permitting the first user of the system to limit the response function for first user controlled functions to other users based upon the level of social connection of the other users to the first user.

In another embodiment of the invention, the method further comprises receiving a request for the response function from a second user for the first user controlled functions, verifying the identity of the second user by means of comparing the first hash value to the second hash value, verifying that the second user is a social connection with the first user at the level of social connection required for the performance of the response function, declining to perform the response function if the second hash value is not substantially identical to the first hash value, declining to perform the response function if the second user does not have the level of social connection with the first user required for the performance of the response function, and performing the response function if the second hash value is substantially identical to the second hash value and if the second user has the level of social connection with the first user required for the performance of the response function. Furthermore, this method may further comprise permitting the first user to further limit the response function for first user controlled functions to other users based upon additional first user created parameters, declining to perform the response function if the second user is not operating within the additional first user created parameters, and performing the response function if the second user is operating within the additional first user created parameters.

### BRIEF DESCRIPTION OF THE DRAWINGS

FIG. 1 is a schematic view of the system.

FIG. 2 is a view of the levels of social connections.

FIG. 3 is a view of the method of the invention.

FIG. 4 is a flow chart of a method used by the invention.

### DETAILED DESCRIPTION OF THE DRAWINGS

Although the present invention will be described with reference to the exemplary embodiments shown in the drawings, it should be understood that the present invention can be embodied in many alternate forms or embodiments.

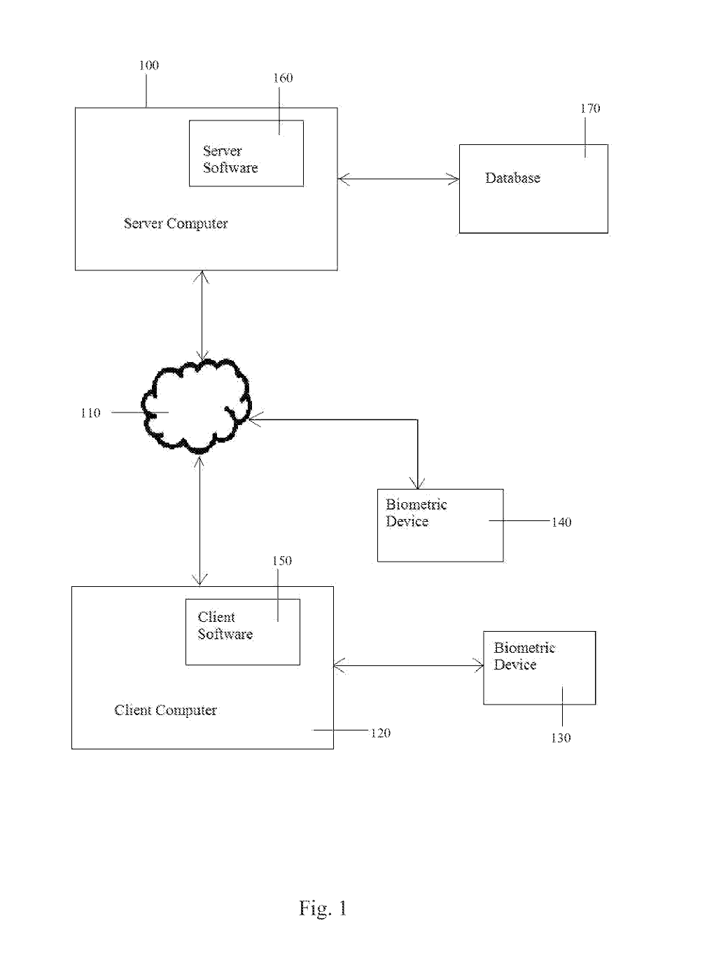

FIG. 1 displays one embodiment oft the system of the invention. The system comprises a server 100 connected to a client computer 120 through a network 110 and a first biometric device 140. The first biometric device 140 is attached to the server 100 through the network 110. In addition, the system comprises a second biometric device 130 which is attached to the client computer 120. The second biometric device 130 may be a standalone device or an integral component of the client computer 120. The system further comprises a database 170 connected to the server 100. The system further comprises a client side software application 150 and a server side software application 160.

The first biometric device 140 may be any type of electronic hardware device which has the capability of receiving biometric information. Such a device may include a camera capable of photographing a user's face, a camera capable of photographing a user's fingerprint, a fingerprint scanner, a microphone for recording a user's voice, or any other device capable of receiving biometric input information regardless of form.

The second biometric device 130 may be any type of device which is similar to the first biometric device 140. In the preferred embodiment the second biometric device 130 is the internal webcam of the client computer 120.

The system is utilized to confirm the identity of a user by using biometric information of the user. The user starts the process by enrolling in an initial verification of the user's identity. In the initial verification process, the user creates a password protected user ID. As part of the process the user creates a user name, a unique password, and links the username to the user's email. The user then inputs the user's biometric information into the system. For example, the user may take a picture of the user's face with the first biometric device 140 or the second biometric device 130. As another example, the user may take scan the user's fingerprints with the first biometric device 140 or the second biometric device 130. Additionally, the user may take a picture of the user's fingerprints with the internal webcam of the client computer 120. The system is set up so that the user may input a plethora of biometric information. For instance, the user may input both a picture of the user's face and a scan of the user's fingerprint, both of which are input into the system and separately connected to the user's profile.

When the user has input the initial biometric information during the enrollment process, the client side software 150 and the server side software 160 process the biometric information so that the database 170 does not store any raw biometric information. The biometric information is processed by a hash algorithm which converts the biometric information into a hash value. The hash value is then stored in conjunction with the user's profile on the database 170.

Hash algorithms convert input information into a unique hash value. A minute change in any input information results in a separate and unique hash value. Therefore, no two hash values are ever identical. In addition, in the event that a user's hash value is ever obtained by third parties, it is impossible to reverse engineer the hash value to obtain the raw biometric information.

In one embodiment of the invention the server side software 160 processes the raw biometric information. In this embodiment the user inputs the biometric information into the client computer 120 through either the first biometric device 140 or the second biometric device 130. The raw biometric information is then transmitted from the client computer 120 to the server computer 100 through the network 110. The server computer 100 receives raw biometric information and applies the hash algorithm to the biometric information by means of the server side software 160. The resulting hash value is then stored on the database 170. The server does not retain or store any biometric information.

In another embodiment of the invention the client side software 150 processes the raw biometric information. In this embodiment the user inputs the biometric information into the client computer 120 through either the first biometric device 140 or the second biometric device 130. The client computer 120 applies the hash algorithm to the biometric information by means of the client side software 150. The resulting hash value is then transmitted from the client computer 120 to the server computer 100 through the network 110. The server computer 100 then stores the resulting hash in the database 170.

In another embodiment of the invention the client computer 120 sends the raw biometric information to the server computer 100 through the network 110. In this embodiment the user inputs the biometric information into the client computer 120 through either the first biometric device 140 or the second biometric device 130. The client computer 120 sends the biometric information to the server computer 100 through the network 110. The server computer 100 applies the hash algorithm to the biometric information by means of the server side software 160. The server computer 100 then stores the resulting hash value in the database 170. The server computer 100 then deletes the biometric information from the server computer 100.

In another embodiment of the invention, the server computer 100 processes the resulting hash created by the client side software 150. In this embodiment the user inputs the biometric information into the client computer 120 through either the first biometric device 140 or the second biometric device 130. The client computer 120 applies the hash algorithm to the biometric information by means of the client side software 150. The resulting hash value is then transmitted from the client computer 120 to the server computer 100 through the network 110. The server computer then applies a second hash algorithm to the hash value received from the client computer 120 by means of the server side software 160. This process creates a second hash value. The server computer 100 then stores the second hash value in the database 170.

After the enrollment process is complete, the server computer 160 and database 170 maintain the user's profile, contact information, password, and hash values. At any time during enrollment, or when the user is logged into the system, the user may add additional biometric information to the system, update biometric information, or make changes to the user's profile.

After completing the enrollment process the system is used to verify the user's identity in a plethora of situations. To verify the user's identity, the user is required to input biometric information into the system by means of the first biometric device 140 or the second biometric device 130. In another embodiment, the user may be required to input biometric information through a client computer or biometric device which was not used by the user to initially input the biometric information. When the user's biometric information is entered at the time of verification, a hash value of the biometric information is created using the same process as at the time of enrollment. After the system has processed the biometric information input at the time of verification the hash value of the biometric information input at the time of verification is compared to the hash value of the biometric information input at the time of enrollment. Ideally, the hash value of the biometric information entered at the time of enrollment will be identical to the hash value of the biometric information entered at the time of verification. If the hash values of the biometric information are identical then the identity of the user has been verified. If the hash values of the biometric information are not identical then the user's identity has not been verified.

In situations that are less than ideal, the hash values may not be identical. This may be due to minor changes which occur during the input process. For instance, lighting may be different when a picture is taken, the user may have changed his or her facial appearance (i.e. different makeup from the time of enrollment, difference in facial hair), or angle of the camera may be different from the angle of the camera at the time of enrollment. In this embodiment, a fuzzy hash algorithm may be utilized. With the fuzzy hash algorithm a hash value for each input of biometric information is created and compared. However, the fuzzy hash algorithm will create a percentage value of similarity between the biometric information input at the time of enrollment versus the biometric information input at the time of verification. If the percentage of similarity is sufficiently high at a predetermined level, then the system will determine that the user's identity has been verified. If the percentage of similarity is not sufficiently high and is below a predetermined level then the system will determine that the user's identity has not been verified. The predetermined percentage of similarity may be changed and modified by the system administrator. The system administrator may change the percentage of similarity to a level where the system administrator is satisfied that the user's identity has been verified.

The user identity verification system may be utilized for any purpose which requires the verification of the identity of a registered user. For example, the system may be utilized to restrict access to a specific area. The system may control access to a locked door which will unlock for a user once the user verifies the user's identity and the user's profile settings indicate that the user has permission to enter through the locked door. During the verification process the user may submit biometric information through the first biometric device 140. If the system verifies the user's identity after comparing the hash value of the biometric information submitted at the time of verification to the hash value of the biometric information submitted at the time of enrollment, then the door to the restricted area will unlock and the user will be permitted to enter the restricted area. The system may be utilized for any purpose necessary to verify the identity of a user. Such purposes may include security staff utilizing the system to verify the identity of a person, restricting access to sensitive or classified electronic files which are for specific individuals only, or requiring a user to prove the user's identity prior to using a client computer.

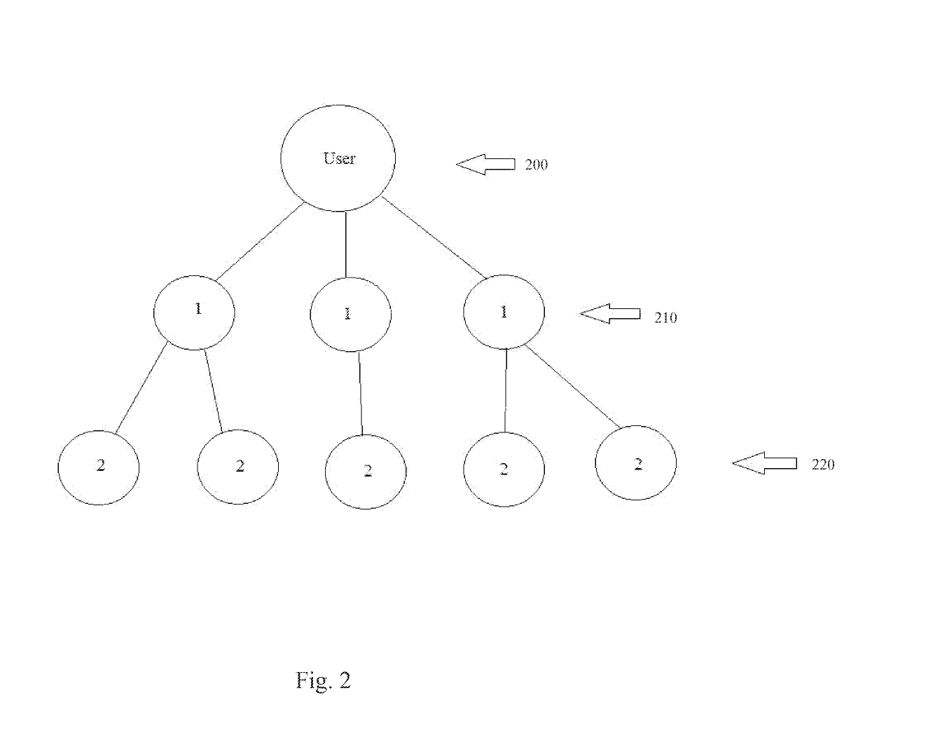

Referring to FIG. 2 the system is also utilized to permit a user to control permissions and access of other users of the system to documents or areas depending on the social relationship of the users. In this embodiment of the invention, the system tracks the social relationship of the users. For instance, a first user 200 may “friend” a second user of the system. The second user is now in the first level of connections 210 of the first user 200. The first user 200 may “friend” any number of other users of the system. The second user may likewise be “friends” with any number of other users of the system. When a second user is “friends” with a third user of the system, the third user is in the first level of connections with the second user. If the third user is not “friends” with the first user 200 then the third user is in the second level of connections 220 with the first user 200. The third user may likewise have multiple other “friends” who are not “friends” with either the second user or the third user. These other friends would be in the third level of connections with the first user 200. Through this process of “friending” the users of the system create a social web. The social web may continue to any level of connections required to incorporate all users of the system.

The system further allows a first user 200 to manage the permissions and access of other users to documents or areas under the control of the first user 200 depending on the level of connection of the other users. For instance, a first user 200 may control access to a room via a locked door. The first user 200 has the administrative ability to control access to the room by other users. The first user 200 may restrict access to the room to the first user 200 and all first level connections 210 of the first user 200. Therefore, only those users who are “friends” with the first user 200 may enter the room via the locked door. In this example, when a second user who is “friends” with the first user 200 approaches the locked door, the second user will be required to verify his identity by submitting biometric information through a first biometric device 140. The system compares the hash value of the biometric information submitted at the time of verification against the hash value of the biometric information submitted at the time of enrollment. The system determines that the hash values are identical, or in the case of a fuzzy hash algorithm sufficiently similar, and thus verifies the identity of the second user. The system then analyzes the social connection of the second user to the first user 200. The system determines that the second user is a first level connection 210 with the first user 200, determines that first level connections 210 of the first user 200 are permitted access to the locked room, and unlocks the door for the second user. However, if the system determines that the second user is a first level connection 210 with the first user 200, but cannot verify the identity of the second user when the second user submits biometric information, the system will not unlock the door.

In the same example, if a third user who is a second level connection 220 with the first user 200 attempts to enter the room, the system will not unlock the door because second level connections 220 do not have permission to enter the room by the first user 200. Thus the third user will not be able to enter the room regardless of whether or not the system verifies the identity of the third user. If the first user 200 permits access to the room to second level connections 220 then the system will unlock the door for the third user once the system verifies the identity of the third user.

In one embodiment, the system will verify the social relationship of the second user prior to requiring the second user to submit biometric information to the system. A user may submit identity information to the system without submitting biometric information. The identity information may be entered into the system in any manner. A user may type a username or a name into the system. Optionally, a user may scan a keycard with the user's identity through a keycard reader.

In another embodiment of the invention, the system allows a user to act as an administrator and set further permission parameters for connections. In this embodiment, the user may further restrict access and permissions for connections based on any number of selected parameters. Such parameters may include time frame, time of day, physical location, or any other user generated parameter. For instance, a first level connection 210 may have permission to access a locked room, but only within a specific time period. This embodiment would be useful in a situation such as if a user wants to permit a plumber to have access to the user's house to make repairs but the user does not want to be home. The user may send an email invitation to the plumber to become a connection on the system. The plumber may enroll in the system. The user could then grant permission to the plumber to enter the user's home during specified hours during the day. When the plumber arrives at the house during the specified hours, the plumber must verify the plumber's identity at the user's house prior to the system unlocking the door for the plumber. If the plumber arrives at the user's house after the specified hours, the system will not unlock the door for the plumber even if the plumber does verify the plumber's identity. In other examples, a user may make a document available to identified users only once a specific time has been reached, such as at a predetermined time of the day. In another example, a user may limit user permissions to access electronic files only from preauthorized client computers in a specific physical location. In this embodiment, a user may grant access to social connections to an electronic file for users who are able to verify their identity provided that the social connections access the electronic file from a preauthorized client computer in a specific physical location. This embodiment would allow coworkers to share access to restricted documents to other users, but only when such other users were at work and not at home.

The invention may be utilized for any point of sale system. Frequently, shoppers are required to prove their identity when paying by check or credit card. In this embodiment, the system is attached in direct communication with a point of sale system. When a user of the system desires to pay by check or credit card, and the recipient desires to verify the identity of the user, the recipient may have the user scan present biometric information to a biometric device in order to confirm the identity of the user.

The invention may be utilized as one system for confirming the identity of users within multiple services. In this embodiment, the user may utilize the system to confirm the identity of a user for unlocking door locks, accessing computers, accessing files on the computer, or during a transaction through a point of sale system. The system may be utilized for any purpose whereby the identity of a person is sought to be verified. Such purposes could include security staff verifying the identity of a user prior to granting access to a building, having a locked door opening only upon user identity verification, having a computer which only allows access to a user once the user verifies the user's identity, having certain electronic files which are only accessible to a user once the user verifies the user's identity, or verifying a user's identity to complete a transaction through a point of sale system.

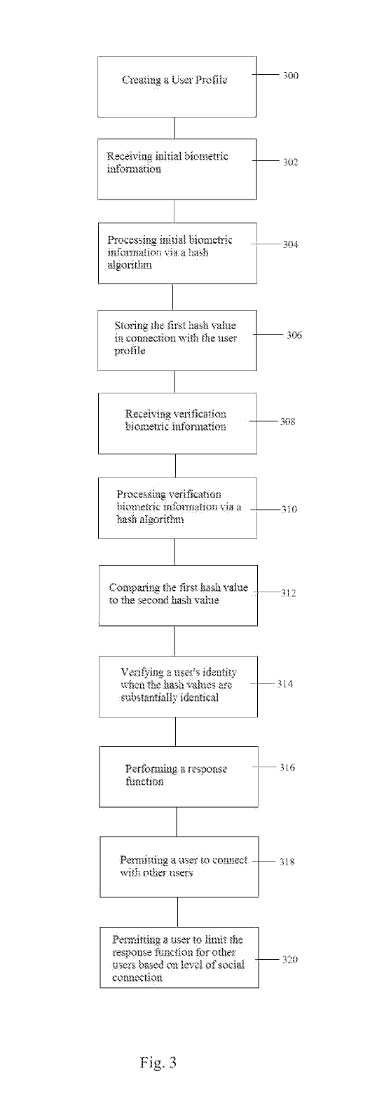

Referring to FIG. 3, the method of the invention comprises the steps of creating a user profile 300, receiving initial biometric information 302, processing initial biometric information via a hash algorithm 304, storing the first hash value in connection with the user profile 306, receiving verification biometric information 308, processing verification biometric information via a hash algorithm 310, comparing the first hash value to the second hash value 312, verifying the user's identity when the hash values are substantially identical 314, performing a response function 316, and permitting a user to limit the response function for other users based on the level of social connection of the other user 320.

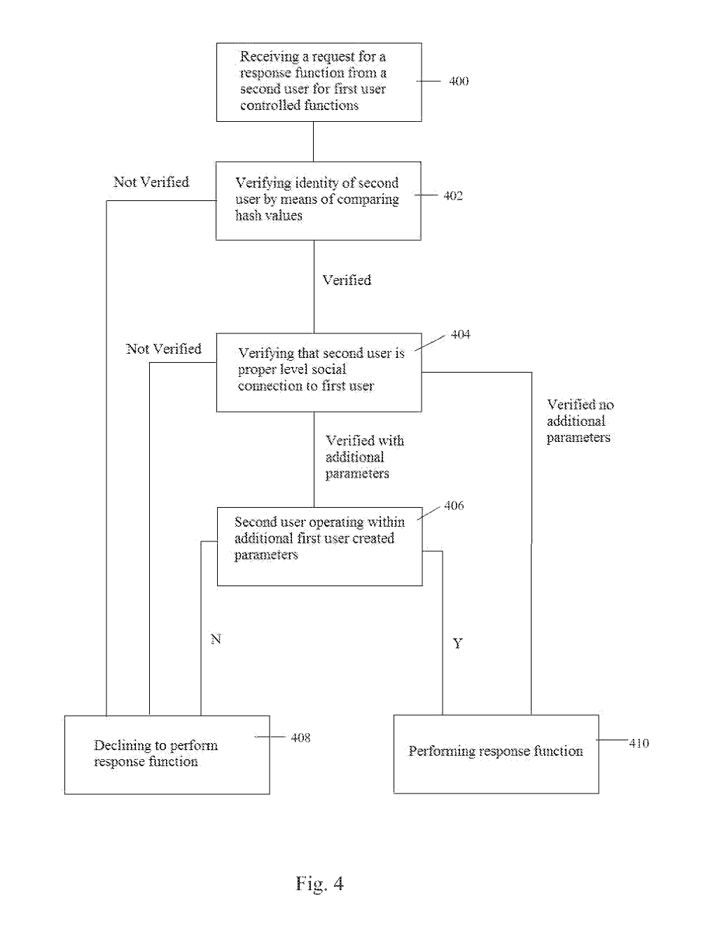

FIG. 4 displays a flowchart of part of the method of the invention. The process begins with receiving a request for a response function from a second user for first user controlled functions 400. First the system verifies the identity of the second user by means of comparing the first hash value to the second hash value 402. If the identity of the second user is not verified then the request to perform the response function is declined 408. If the identity of a second user is verified, then the system verifies that the second user is a proper level of social connection to the first user 404. If the second user is not at the proper level of social connection to the first user 200, then the request to perform the response function is declined 408. If the second user is at the proper level of social connection to the first user 200, and there are no additional restrictive parameters then the response function is performed 410. If the second user is at the proper level of social connection to the first user 200 and there are additional restrictive parameters then the system determines whether the second user is operating within the additional first user created parameters 406. If the second user is not operating within the additional first user created parameters then the request to perform the response function is declined 408. If the second user is operating within the additional first user created parameters then the response function is performed 410.

1. A system for verifying biometric information comprising
A client computer
A server computer
Wherein said client computer and said server computer are connected through a network
A first biometric device
Wherein said biometric device receives biometric information
A first software application
Wherein said first software application processes initial biometric information by means of a hash algorithm to create a first hash value
Wherein said first software application processes secondary biometric information by means of a hash algorithm to create a second hash value
Wherein said first software application compares said first hash value to said second hash value
Wherein said first software application verifies the identity of a user based upon the results of said comparison.

2. The system as in claim 1 further comprising
a database connected to said server computer
wherein said database stores information regarding a user in connection with the first hash value.

3. The system as in claim 2
Wherein said first biometric device is connected to said client computer.

4. The system as in claim 2
Wherein said first biometric device is connected to said server computer through a network.

5. The system as in claim 3
Further comprising a second biometric device
Wherein said second biometric device is connected to said server computer through a network.

6. The system as in claim 3
Wherein a user is verified when said second hash value is identical to said first hash value.

7. The system as in claim 3
Wherein a user is verified when said second hash value is substantially identical to said first hash value
Wherein a system administrator may vary the percentage of similarity required between said first hash value and said second hash value for such similarity to be determined substantially identical.

8. The system as in claim 7
Wherein the system performs a response function when said first hash value is substantially identical to said second hash value.

9. The system as in claim 8
Wherein a first user of the system may connect with other users of the system into a social network
Wherein said first user of the system may limit said response function for first user controlled functions to other users based upon the level of social connection of said other users to said first user.

10. The system as in claim 9
Wherein said first user may further limit said response function for first user controlled functions to other users based upon additional first user created parameters.

11. The system as in claim 10
Wherein said first software application resides on said client computer.

12. The system as in claim 10
Wherein said first software application resides on said server computer.

13. The system as in claim 1
Wherein said first software application resides on said client computer
Wherein said client computer transfers said first hash value to said server computer.

14. The system as in claim 1
Wherein said first software application resides on said server computer
Wherein said client computer transfers biometric information to said server computer.

15. A system for verifying biometric information comprising
A client computer
A server computer
A database connected to said server computer
wherein said database stores information regarding a user in connection with the first hash value
Wherein said client computer and said server computer are connected through a network
A first biometric device
Wherein said biometric device receives biometric information
Wherein said first biometric device is connected to said client computer
A first software application
Wherein said first software application resides on said server computer
Wherein said first software application processes initial biometric information by means of a hash algorithm to create a first hash value
Wherein said first software application processes secondary biometric information by means of a hash algorithm to create a second hash value
Wherein said first software application transmits said first hash value and said second hash value to said server computer through a network
A second software application
Wherein said second software application resides on said server computer
Wherein said second software application processes said first hash value by means of a hash algorithm to create a third hash value
Wherein said second software application processes said second hash value by means of a hash algorithm to create a fourth hash value
Wherein said second software application compares said third hash value to said fourth hash value
Wherein a user is verified when said third hash value is substantially identical to said fourth hash value
Wherein a system administrator may vary the percentage of similarity required between said third hash value and said fourth hash value for such similarity to be determined substantially identical
Wherein the system performs a response function when said third hash value is substantially identical to said fourth hash value
Wherein a first user of the system may connect with other users of the system into a social network
Wherein said first user of the system may limit said response function for first user controlled functions to other users based upon the level of social connection of said other users to said first user
Wherein said first user may further limit said response function for first user controlled functions to other users based upon additional first user created parameters.

16. A method of biometric verification comprising
Creating a user profile for a user
Receiving initial biometric information from the user during an enrollment process
Processing said initial biometric information by means of a first hash algorithm to create a first hash value
Storing said first hash value in connection with said user profile
Receiving verification biometric information from the user during a verification process
Processing said verification biometric information by means of a hash algorithm to create a second hash value
Comparing said first hash value to said second hash value
Verifying said user's identity when said first hash value and said second hash value are substantially identical
Wherein a system administrator may vary the percentage of similarity required between said first hash value and said second hash value for such similarity to be determined substantially identical.

17. The method as in claim 16 further comprising
Performing a response function when said first hash value and said second hash value are substantially identical.

18. The method as in claim 17 further comprising
Permitting a first user of the system to connect with other users of the system into a social network
Permitting said first user of the system to limit said response function for first user controlled functions to other users based upon the level of social connection of said other users to said first user.

19. The method as in claim 18 further comprising
Receiving a request for said response function from a second user for said first user controlled functions
Verifying the identity of said second user by means of comparing said first hash value to said second hash value
Verifying that said second user is a social connection with said first user at the level of social connection required for the performance of said response function
Declining to perform said response function if said second hash value is not substantially identical to said first hash value
Declining to perform said response function if said second user does not have the level of social connection with said first user required for the performance of said response function
Performing said response function if said second hash value is substantially identical to said second hash value and if said second user has the level of social connection with said first user required for the performance of said response function.

20. The method as in claim 19 further comprising
Permitting said first user to further limit said response function for first user controlled functions to other users based upon additional first user created parameters
Declining to perform said response function if said second user is not operating within said additional first user created parameters
Performing said response function if said second user is operating within said additional first user created parameters.
